(19) United States
(12) Patent Application Publication
(10) Pub. No.: US 2017/0243306 A1
(43) Pub. Date: Aug. 24, 2017

(54) MULTIPLE DATABASE APPLICATION FOR CREATING AND COORDINATING FOOD ORDERS FOR GROUPS

(71) Applicant: Andrew Lloyd Lenczycki, McKinney, TX (US)

(72) Inventor: Andrew Lloyd Lenczycki, McKinney, TX (US)

(21) Appl. No.: 15/422,951

(22) Filed: Feb. 2, 2017

Related U.S. Application Data
(60) Provisional application No. 62/298,999, filed on Feb. 24, 2016.

(51) Int. Cl. G06Q 50/12; G06Q 30/06; G06F 17/30

(52) U.S. Cl. CPC G06Q 50/12; G06F 17/30876; G06Q 30/0635

(57) ABSTRACT

A method using enabling technology and communications to facilitate and capture an individual's menu selections from a merchant within a group to form a consolidated group order which is to be presented to a merchant where the method implements dynamic routines influenced by personal preferences, location based services and other commonalities between the individuals forming the group.

### CROSS-REFERENCE TO RELATED APPLICATION 35 USC §119(e)

Priority is claimed from U.S. provisional application for patent 62/298999, filed on Feb. 24, 2016, which is hereby incorporated by reference. This application may be related to the present application, or may have some drawings and/or disclosure in common.

### FIELD OF INVENTION

The present invention details a computer application and computer methods that allow users to create succinct and complete group order lists for placing consolidated orders with merchants while maintaining the integrity of the individual order within the group list with minimal effort.

### BACKGROUND OF INVENTION

The current state of the art allows for some ordering functionality at specific and individual locations (proprietary restaurants or chains using a proprietary application for ordering). However, these applications lack group ordering functionality, and often times a proprietary application is needed to order at each different restaurant. In other words, if you want to order from restaurant A, you need restaurant A's application or follow their methods. The same goes for every other restaurant or merchant.

The food industry is quickly moving into application-driven and computerized ordering platforms. Larger restaurant chains are making changes that allow customers to place an order at their restaurant using kiosks or computer applications, and this service comes in several different ways depending on the application. However, with so many different applications and ways to order, it can become confusing for the customer who may have to go through a number of different applications and ordering platforms depending on the number of restaurants or merchants which they frequent.

In addition, these applications only offer support for single-customer ordering; which makes ordering for a group particularly difficult. The proposed invention seeks to enable a centralized and convenient application that utilizes several databases and methods that give the user a quick and accurate way to create group order lists; and, which allows their friends and colleagues to place orders embedded within the group order, and will recall the orders at any given time. Additionally, users can save order information by signing up for an optional account.

The present embodiment is an answer to the problem of the current convolution of the modern “food run.” This invention seeks to remedy the issue of complexity in group ordering by creating an application that empowers the user to create a group order list, populate it however they like, and empower the user to select the best way to order their food or merchandise. It accomplishes these tasks effectively and with a manner that is minimalistic, efficient, and convenient. The present embodiment presents a richer food-ordering landscape that allows multiple users to coordinate orders while eliminating the frustration out of having to work with a fragmented market of applications who serve a single purpose for a single restaurant.

The present embodiment is useful towards restaurants, merchandise retailers, admission by ticket venues and other hosted events where a group order might originate.

### SUMMARY OF INVENTION

The following presents a simplified summary to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

In the preferred embodiment of the present invention, a web based application utilizing multiple databases provides users functionality to create group order lists, place orders in those group order lists, recall all orders within the order list, and to save favorite orders for later use while utilizing account features that users can opt into by providing certain information reflecting their individual preferences.

The present embodiment would be accessible on multiple devices and utilize different user experiences and interfaces that are more accessible for the given device. This allows for the preferred embodiment to be used on a range of web enabled devices without the need for a standalone application written in the device's native language or application framework. Other embodiments of the invention may include specific applications for different devices and frameworks.

In one feature of the present invention, the user can create a group order list for a restaurant they desire and allow others to place additional orders in that list. A specific feature of the present embodiment allows users to create orders in another user's order list; provided they have the group order list's unique number and enter it into the application.

Still another feature of the present embodiment allows users to recall all orders that are tied to one group order list by entering that particular group order's unique number. And yet another feature of the present embodiment enables users to save their favorite orders for recall; and, when desired, insert their order into a group order list at a later point in time.

The present embodiment also enables merchant participation and provides benefits to merchants as well. Through implementation of advanced analytics and location based services, merchants can provide loyal customers improved customer experiences to reward loyalty, offer promotions and provide alerts to help the user plan their visit. The present embodiment enhances locating services using modified search methods which are utilized to categorize and index merchants based on multiple criteria utilized during the preference routine in the logic.

This feature also provides methodology to generate and enable “short cuts” presented to the user to enhance the user experience. These features can benefit both the consumer and the merchant which can enhance the perception of the merchant in the eyes of the market it serves.

Other specific consumer benefits are enabled through the present embodiment. One feature in particular, supports the consumers desire to eat healthy. When the user enters a profile, a “healthy” menu option may be offered. The analytics and features elements of the present embodiment can high light menu selections which fit the profile of the user's preferences. Merchant can offer ingredient substitutions as well; which, allow the individual to be selective about the individual order, even though a group order is being prepared. Other features can utilize the embedded analytics to “reward” the healthy consumer by informing them that “it's ok for a treat” based on a rolling tally as to when the last time the consumer splurged on a brownie or scoop of ice cream.

Consumers can also use the application to track a spending budget, and use cumulative spending tallies to assist the consumer to stay on budget each time a menu is analyzed.

And for those users with severe medical concerns or simple allergies, additional messages can be attached to the order for when the merchant processes the order to avoid use of individually dangerous ingredients like peanut oil or nuts. The merchant can also add such alerts to the menu that the user is viewing to let the consumer know if such ingredients are present in the facility or in the food being prepared.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, regarding the following figures.

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1: Creating a Group Order List—This drawing outlines a simple process and typical use for a user wanting to start new group order list. The steps detailed are the minimum steps needed to accomplish the task, making the method both a typical use and the optimal use of this particular feature of the invention.

FIG. 2: Placing an Order in A Group Order List—This drawing outlines the steps and typical use case for a user who wishes to place an order in a group order list. The steps outlined are the shortest and are thus the most optimal while still being the typical use for this particular feature of the invention.

FIG. 3: Recalling All Orders in a Given Order List—This drawing outlines the typical steps taken to recall all orders in a given group order list. The steps detailed are the minimal number of steps to accomplish this task, thus making these steps the optimal steps as well as the typical use case.

FIG. 4: Saving a Favorite Order Using Optional Features Introduced Using an Account System—This drawing outlines the steps that are required of a user to save their order as a favorite order for later use. The drawing assumes the user has signed up for an optional account feature and opts to using these features. Assuming the user has an account, the steps detailed are the quickest and most intuitive way to accomplish this task.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION

The claimed subject matter is now described with reference to the drawings. In the following description, for purposes of explanation, numerous specific details are set forth in order to provide a thorough understanding of the claimed subject matter. It may be evident; however, that the claimed subject matter may be practiced with or without any combination of these specific details, without departing from the spirit and scope of this invention and the claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be routine undertaking for those of ordinary skill in the art having the benefit of this disclosure.

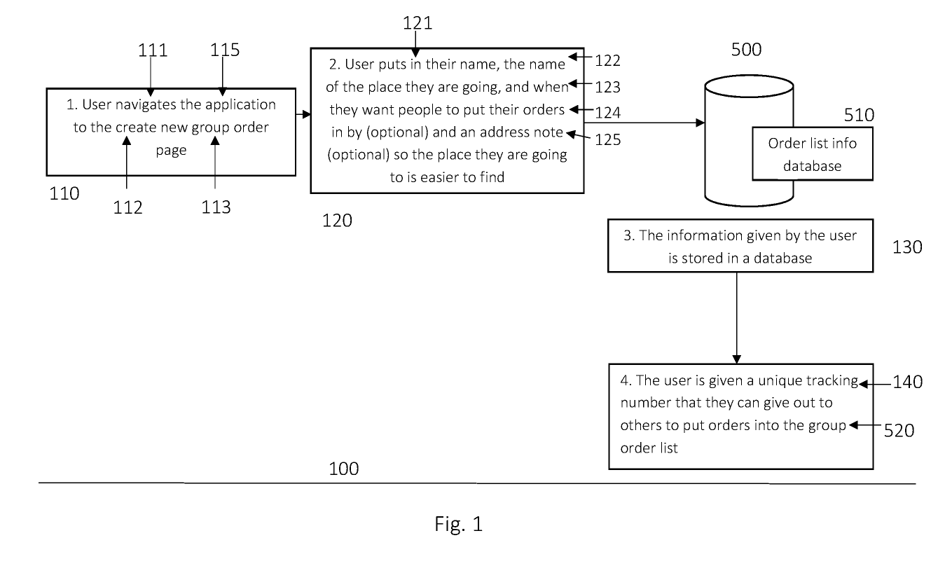

FIG. 1 illustrates the process to create 100 a group order list 520. To begin, the user initiates 110 the application 115 and navigates 111 using screen selections to create 112 the new group order page 113. Once the new group order page 113 is created, the user proceeds to the input sequence 120 where the uses inputs 121 the user's identity and inputs 122 the merchant identification and establishes 123 an open period, also called the addendum duration, for others to join the group order list 520. The other users can also input 124 their orders to be added to the group order list 520. The addendum duration 123 is set which defines the interval of time during which additional inputs 121, 122, and 124 to the group order list 520 will be accepted. The user can add additional details, such as the merchant address 125 to assist other users in locating the merchant. Alternatively, logic stored in the computer database system 500 will append location information in the form of the merchant address 125 to the group order list 520 for all users to see.

Each user can store their inputs 113, 121, 122 and 124 to the order list information database 510 within the computer database system 500 by saving 130 the data using the application 115. Once saved 130, the order list information database 510 will assign a unique tracking number 140 for recall the group order list 520. The present embodiment also can allow additional users who choose to join their inputs 113, 121, 122 and 124 to the existing group order list 520 may do so by selecting to save 130 their order to the group order list 520 with the same unique tracking number 140.

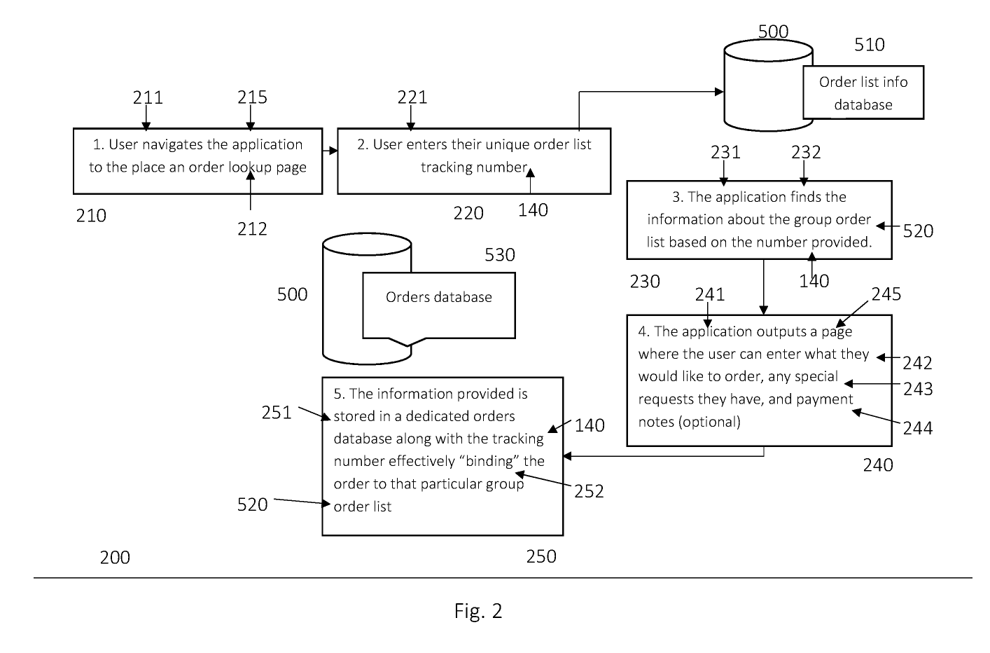

FIG. 2 illustrates the process to place 200 an order in the group order list 520. First, the user initiates 210 the application 215 and navigates 211 using screen selection to the place order lookup page 212. Next, the application outputs a user editable field wherein the user enters a unique tracking number 140. The unique tracking number 140 is used as an index for searching within the computer database system 500 and the order list info database 510 therein, which contains the group order list tracking number 140 along with information about who created the order list 520. Once validated by means of search in the computer database system 500 and the order list info database 510, the sequence proceeds to the search function 230. In the search function 230, the application 231 invokes methods of search on the computer database system 500 and the order list info database 510. The results 232 of this search method to retrieve the group order list 520 is returned for further use in reviewing, submitting or revising the order.

Once the group order list 520 is retrieved 232, the user has the option to enter specific details using the application 241 to navigate to the place order page 245. On the place order page 245, the application 241 outputs user editable fields 242 where the user inputs what they would like to order, including any special requests 243 they have, and any payment notes 244 that are relevant. Once the user submits this form 240 by means of screen selection, the application invokes the means of storing 250 the information provided 242, 243, 244 in 530 the orders database, and invoking the method of retrieving 232 the unique tracking number 140 for the group order list 520 and binding 252 this number 140 along with the user inputs 242, 243, 244, in the order database 530; which effectively concatenates the multiple individual order data to the group order list 520.

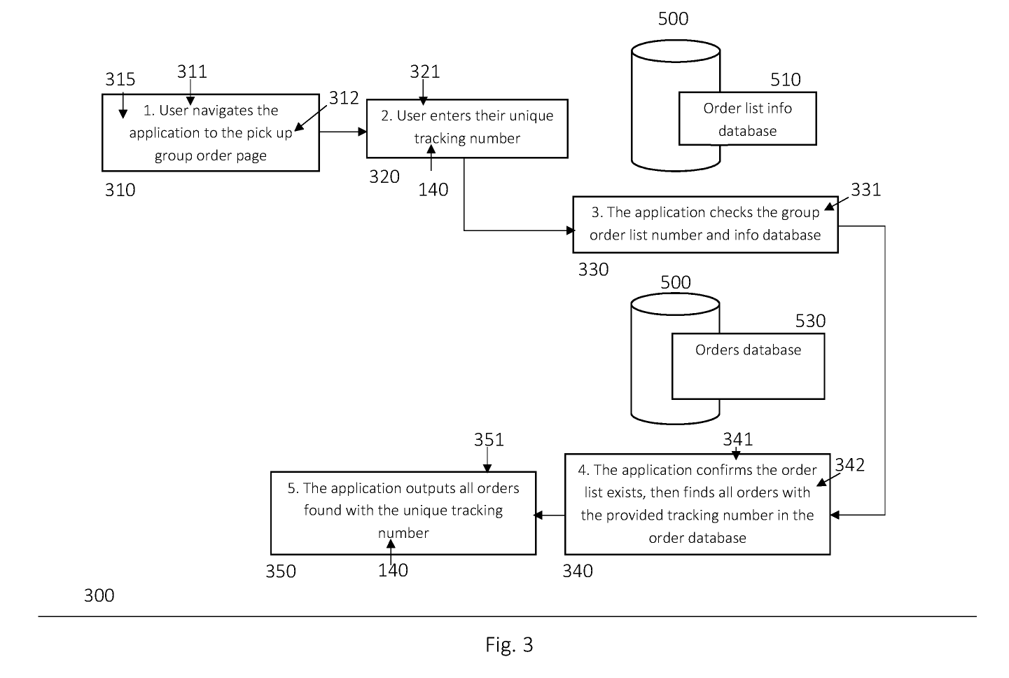

FIG. 3 illustrates the process to 300 recall all orders in a given 520 group order list. Initially the user utilizes 310 the application 315 and navigates 311 using screen selections to the 312 pick-up group order lookup page. The application then invokes 320 by outputting a user editable field where users inputs their unique tracking number 140 into the field 321 generated by the page 320 which then uses the unique tracking number 140 as an index for searching in 510 the order list info database. The application then invokes 330 methods of search in 510 for information 331 regarding the group order list 520.

Once validated by means of searching 331 the order list info database 510 for the existence of an order list 520 identified by 140 the unique order list tracking number, the application invokes the means of retrieval and search 340 within the orders database 530 and retrieves 342 all orders in 530 the orders database that belong to 520 the order list by means of being bound with the unique order list identifier number 140. The application then navigates the user to the order list order output page 350 where the application 351 outputs all order information found in 530 the orders database that is bound to 520 the order list which is identified by the unique order list identifier number 140.

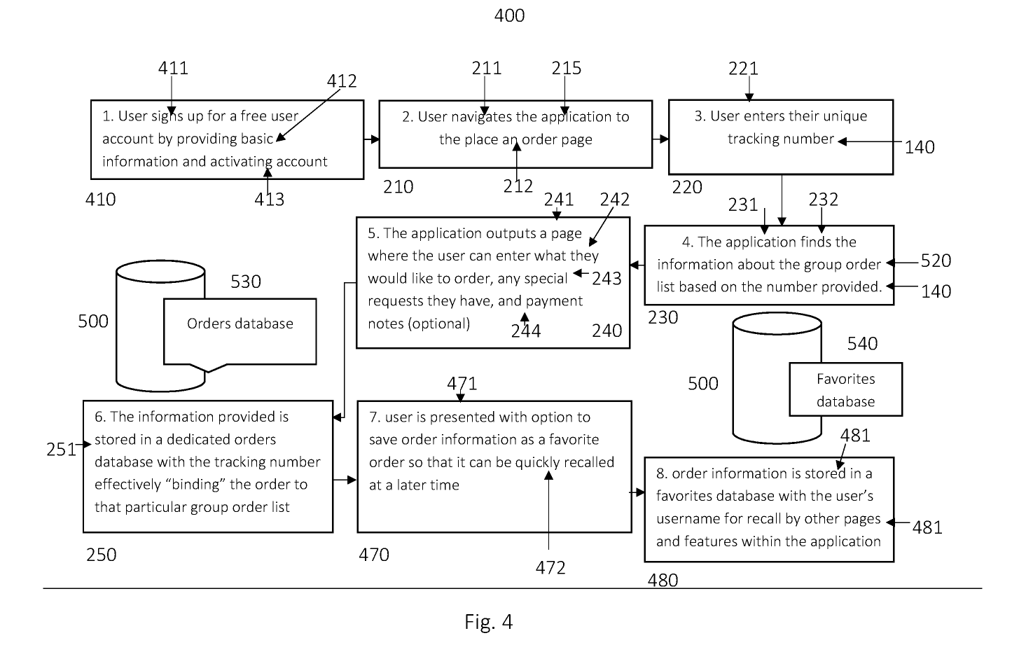

FIG. 4 illustrates the process of saving an order as a favorite 400 given that the user has enrolled 410 for a user account for use within the application. The user registers for a free user account 411 and inputs some certain and basic information 412 which is stored and allows them to sign up for a user account 411 and 413 activate that account 411 for use within the application. Once registered, the user initiates 210, by navigating 211 the application 215 to the place an order lookup page 212 by means of screen selection. On the page, the user inputs 221 the unique order list tracking number 140 into the page 220 and submits the form by means of screen selection. The application then invokes 230, means of searching 232 the order list info database 510 for information about the group order list 520 based on the unique tracking number 140 provided. The application 241 then navigates to 240 and outputs the place order page where the user inputs 242 what they would like to order, any special requests 243 that they have, and optional payment notes 244 that they deem pertinent. The application then invokes 250 which stores 251 the user provided information 241, 242, 243, 244 in the orders database 530 along with the unique order list identifier number 140 which effectively binds the order to the group order list 520.

The application then invokes 470 wherein the user is presented with the option 471 to save the order 251 they just placed by means of screen selection so that the order 251 can be recalled 472 for used by other features of the application at a later time. If the user chooses to save their order 251, the application invokes 480 methods of storage of the favorite designation 481 in the user favorites database 540 wherein the information supplied by the user 241, 242, 243, 244 is 481 stored in 540 the favorites database. From there the application can recall the favorite designation 481 and associated data by means of search in 540 the favorites database the user supplied information 241, 242, 243 and 244 for use by the application and its various features at a later time.

Although the preferred embodiment has been described in detail, it should be understood that various changes, substitutions and alterations can be made therein without departing from the spirit and scope of the invention as defined by the appended claims.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim:

1. A method that allows users to accomplish tasks related to making group order lists within a software application comprising:
A computer device with memory, processor and data input and output functions;
Computer database system;
Remote database servers and databases;
A user manipulated software application;
Input interface;
Internet access;
Location base services;
Orders;
Group order list function;
Group order list unique number;
Concatenating function;
Appending and Amending functions;
Recall function;
User populated database of merchants;
User preferences;
Payment functions; and
Analytics functions.

2. The method in claim 1 which allows a user to utilize the software application resident on the computer device to initiate placement of an order with a merchant, the order to which additional users may append and amend additional orders forming a concatenated order further comprising:
a group order list;
the group order list's unique number;
method allowing users to recall all orders in a particular group order list;
method allowing users to amend an order;
method allowing other users to append the orders; and,
method allowing users the ability to save their favorite orders for later use with other features of the application;

3. Where the method for claim 1 which allows a user to create a group order which comprises:
users name;
merchant with whom they would like to place order;
multiple additional pertinent details to goods and services available from the merchant;
multiple additional pertinent details reflecting the user's preferences;
such details which are input by the user and stored by the application.

4. Where the method for claim 1 which allows users to place an individual order within a group order list further comprising:
the user entering the group order list unique number into the application;
presentation of the input interface for entering the order, special requests, and additional pertinent details to the order; and
functions within the application to consolidate the group order list on the remote database servers.

5. Where the method for claim 1 which allows users to recall all orders in a particular group order list further comprising:
remote databases containing order information related to the particular group order list;
a user inputting the group order list unique number using the application;
the application retrieving at least some relevant order information from at least one of the databases resident on at least one of the remote database servers;
recall function initiated by the user entering the group order list's unique number.

6. Where the method for claim 1 which allows users to save their favorite orders comprising:
a user signing up for an optional account and using said account to access services and methods within the application that allow for the storing within the database, order information such as the order itself, special requests regarding the order, and relevant details that can be provided by the user.
